(19) United States
(12) Patent Application Publication
(10) Pub. No.: US 2013/0193307 A1
(43) Pub. Date: Aug. 1, 2013

(54) SYSTEM, METHOD, AND DEVICE FOR SUPPRESSION OF DARK CURRENT

(71) Applicants: David Sander, Rockville, MD (US); Pamela Ann Abshire, Silver Spring, MD (US)

(72) Inventors: David Sander, Rockville, MD (US); Pamela Ann Abshire, Silver Spring, MD (US)

(73) Assignee: UNIVERSITY OF MARYLAND, College Park, MD (US)

(21) Appl. No.: 13/696,186

(22) PCT Filed: May 5, 2011
(86) PCT No.: PCT/US11/35415

§ 371 Date: Mar. 21, 2013

Related U.S. Application Data
(60) Provisional application No. 61/331,653, filed on May 5, 2010.

(51) Int. Cl. H04N 5/361

(52) U.S. Cl. CPC H04N 5/361
USPC 250/208.1

(57) ABSTRACT

A method, system and device for reducing dark current, by clamping the voltage across the photodiode to about zero using local storage of charge, in an array of pixel cells in which each pixel cell has a photodiode configured to receive light and generate a photocharge during an integration period.

### PRIOR RELATED APPLICATION DATA

This application claims priority to U.S. Provisional Patent Application Ser. No. 61/331,653, filed May 5, 2010, which is incorporated by reference.

### FEDERAL FUNDING

The invention described herein was supported at least in part by the National Science Foundation (NSF) under award ISS0515873. The United States has certain rights in the invention.

### TECHNICAL FIELD

The disclosed embodiments relate to semiconductor imaging devices, and more particularly relate to systems, methods, and devices for suppression of dark current in semiconductor imaging equipment.

### BACKGROUND

Low-light detection of signals represents an important class of problems from biological to space applications. For the development of ubiquitous sensor systems, these sensors must have high sensitivity, low noise and robustness—all while maintaining a low cost. “Dark current” refers to charge that alters a pixel signal and which is generated by thermal energy, not by light detected by a photosensor. Such charge can aggregate with photocharge at the integration node of a pixel cell, and thereby increase the total charge sensed at the integration node and read out as a pixel signal. Dark current sources include, for example, leakage currents across junction diodes between p- and n-type seminconductors.

Noise in the output signal arises both from photon shot noise associated with the incident photosignal and from readout noise contributed by devices along the readout chain. While the average dark current is constant for a given integration period and thus can be subtracted from the output, the instantaneous photocurrent is subject to shot noise. The statistics of the input signal closely may resemble a Poisson process, and the random fluctuations due to this generation process degrade the signal-to-noise ratio of the system. Readout noise results from many sources including thermally generated noise, shot noise, and flicker noise in the transistors along the readout path. The specific magnitude and spectral content of the noise can depend on both the design of the system as well as the material process parameters. The readout noise of the sensor is due to the intrinsic physical noise sources of the MOSFETs in the pixel buffer amplifier (typically configured in a source follower configuration) and readout buffer. The noise sources in the transistors include 1) thermal noise due to the random thermal motion of the electrons in the channel and 2) flicker noise due to mobile carriers being trapped or released from interface traps at the silicon-oxide interface. The rate of thermally generated electron-hole pairs depends on material properties, device geometry, and biasing conditions.

The presence of dark current increases the total number of carriers at the integration node. Given the voltage supply rails and specific operating characteristics of the pixel circuit, there is a maximum number of such carriers that may accrue on the integration node before the voltage signal there saturates. Beyond that value, additional carriers have no effect on the voltage. For weak incident light, the carriers contributed by the dark current may constitute a majority of the total integrated carriers. Thus, due to the limited dynamic range at the integration node, the presence of dark current limits the ability to integrate photo charge.

Accordingly, there is always a need for a system, method, and device that mitigates dark current. It is to this need, among others, that this disclosure is directed.

### SUMMARY

This application discloses a method, system and device for reducing dark current, by clamping the voltage across the photodetector to about zero using local storage of charge, in an array of pixel cells in which each pixel cell has a photodiode configured to receive light and generate a photocharge during an integration period.

### BRIEF DESCRIPTION OF THE DRAWINGS

FIG. 1 is an example of a photodetector that can be clamped to a voltage;

FIG. 2 is another example of a detector that can be clamped using an amplifier in a feedback configuration;

FIG. 3 is a circuit diagram illustrating a non-limiting example of one specific embodiment of a photodetector comprising a floating-gate based capacitive trans-impedance amplifier (CTIA) pixel with a random access peripheral;

FIG. 4 shows one specific embodiment of a monolithic device having a pixel cell array with rows and columns of pixel cells;

FIG. 5 is one example of a suitable CTIA architecture for use with certain specific embodiments;

FIG. 6 is an exemplary chip layout;

FIG. 7 shows exemplary injection/tunneling structures of a suitable CTIA in which the positive and negative input terminals are held constant throughout the integration cycle;

FIG. 8 shows illustrative data of the noise associated with the dark current for each pixel with UV erasing and mismatch compensation programming;

FIG. 9 is a block diagram illustrating a non-limiting example of programming which may employed with certain embodiments described herein.

FIG. 10 shows one example of a capacitive trans-impedance amplifier modified to include a floating gate;

FIG. 11 shows one specific implementation of charge injection and tunneling structures for illustrative purposes.

### DETAILED DESCRIPTION

The accompanying drawings illustrate specific embodiments of the invention which are provided to enable those of ordinary skill in the art to make and use them. It should be understood that the embodiments are not limited to their illustrations and written descriptions or limited to the examples of circuits and architectures disclosed herein. Structural, logical or procedural changes may be made.

To achieve repeatability of performance of an imaging system, it may be necessary to compensate for or remove sensor and illumination artifacts in the system. An imaging device or system can be made up of an illumination system for illuminating an object, an optical system for projecting an image of the object on to an image detector, and hardware and software for producing a computer and/or human readable output for further evaluation. One purpose in imaging an object is to quantify the amount of light emitted at each point on the target, so as to most accurately map the radiant emittance from each point on the object.

One specific embodiment includes a method for suppressing dark current in a photodetector comprising a photodiode configured to receive light and generate a photocharge during an integration period. In such a detector, the dark current can be suppressed by clamping the voltage across the photodiode to zero using temporary localized storage of charge. A programmable memory structure in each pixel can allow an arbitrary bias voltage to be asserted for each pixel thus allowing for the optimization of the performance on a pixel-by-pixel basis. Such an arrangement may be carried out for a single detector or for an array of detectors for applications in which multiple detection sites must be monitored simultaneously or an image of the incident scene is desired.

Although silicon fabrication technologies are commercially available, such technology may not allow very weak light detection because the underlying dark current in silicon is often several orders of magnitude higher than in competing technologies. Even across these materials, the dark current can be suppressed by imposing a zero voltage bias across the detector. In practice, however, the voltage across the photodiode terminals should be very close to zero or about zero in order to realize the benefit from this technique.

The phrase “almost zero” or “about zero,” as used herein can mean a voltage that is close to zero. In some embodiments, it may be possible to obtain less than 100 μV precision. Capacitive techniques can be limited to the same range and can suffer from some degree of leakage. Digital-to-analog conversion (DAC) based compensation can be as small as 25 μV, and can depend on the number of bits in the DAC and therefore area of the DAQ. To achieve 25 μV precision, given a standard deviation of 8 mV across pixels, some examples may incorporate at least 8 bits in the DAQ and 10 bits to achieve compensation for pixels with 3 sigma deviation. As technology improves the degree of control over the programmable memory, the voltage can be clamped closer to zero.

In one example, the method for implementing the photodiode bias was precise. Under a typical circumstance, there is fabrication mismatch among the components which are used to assert the photodiode bias voltage. This mismatch limits the precision with which the photodiode voltage can be set to almost zero, and limits the effectiveness of the dark current suppression that is possible using such a method. The introduction of local memory or storage is an enabling factor that can allow zero detector bias to be realized with very high precision. In specific embodiments, this local memory can be used to achieve offset correction of the components that hold the detector at a zero bias voltage in a feedback configuration. However, in alternative implementations, particularly in array configurations where density is a critical consideration, similar results may be achieved under restricted operating conditions by using calibrated values in the local memory in the absence of feedback.

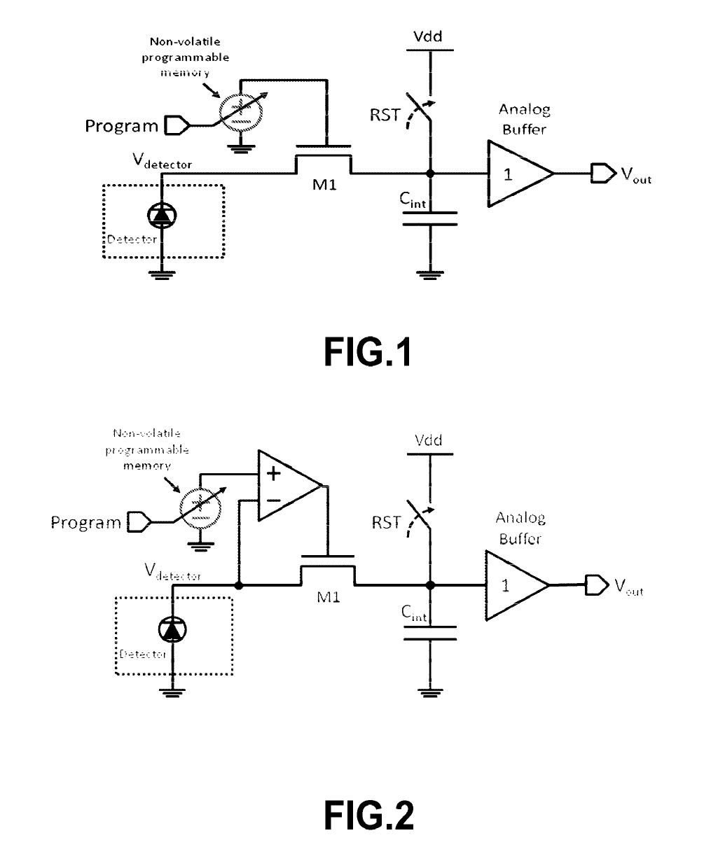

In one specific embodiment, the photodiode bias voltage can be clamped by numerous structures and in numerous configurations available to those with skill in the art. For example, as shown in FIG. 1, the detector can be clamped to a voltage which is a function of the programmable memory and the current through the amplifier. This implementation uses a local memory or storage to set the bias voltage on a single transistor which is configured as a common gate amplifier (M1) with the photodiode at its source and the integration node at its drain. After the integration node is reset to the upper power supply voltage, the voltage at the integration node decreases as current is drained away through transistor M1. The current through M1 can be then determined by the sum of the dark current and the photocurrent. In this configuration the voltage at which the photodiode detector is clamped depends on the value of the programmable memory and also on the current through the amplifier.

In another example, as shown in FIG. 2, the detector can be clamped using an amplifier in a feedback configuration that senses the voltage at the detector node and compares the voltage against the programmable bias. The amplifier outputs a voltage to the gate of M1. The transistor M1 can be configured as a common gate amplifier with the photodiode at its source and the integration node at its drain. After the integration node is reset to the upper power supply voltage, then the voltage at the integration node decreases as current is drained away through transistor M1. In this implementation, the local memory or storage applies a voltage not to the gate of M1 but rather to the positive terminal of an amplifier. To maintain the optimal voltage at the detector node, an amplifier is used in feedback configuration to compare the detector node voltage to the programmable bias voltage. The amplifier produces an output which drives the gate of transistor M1, raising the gate voltage when the detector voltage is too low and decreasing the gate voltage when the detector voltage is too high. It therefore can clamp the voltage bias across the detector at a value equal to the local memory.

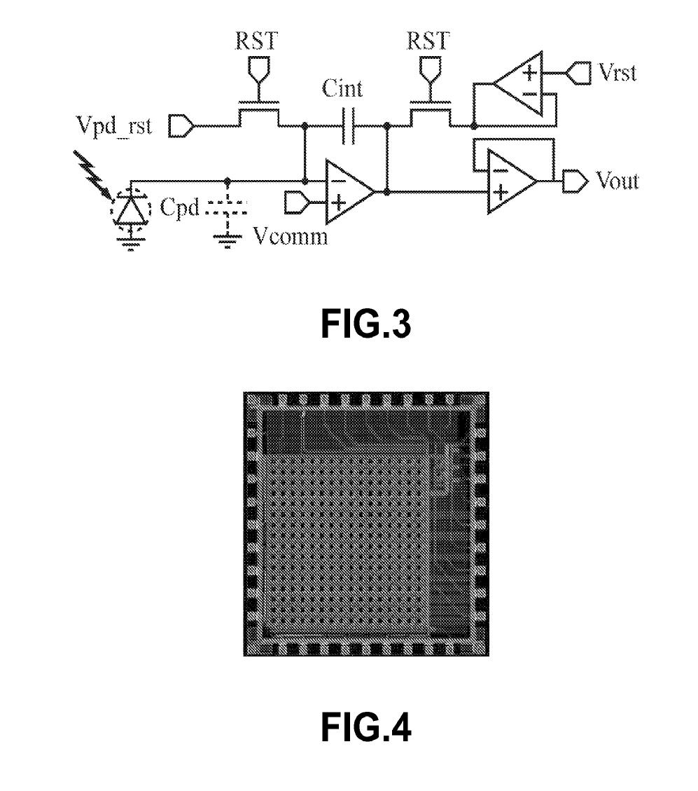

FIG. 3 shows a schematic drawing of one specific embodiment of a photodetector comprising a floating-gate based capacitive trans impedance amplifier (CTIA) pixel with random access peripheral control to allow multiple nondestructive sampling of each pixel and to provide statistics about the system performance. Each pixel cell can have a photodiode configured to receive light and generate a photocharge during an integration period. The photodiode can be connected to the negative terminal of the CTIA amplifier with an NMOS transistor acting as a switch between the photodiode node and an external reset voltage Vpdrst. CTIA pixels can use a trans-impedance amplifier with a capacitor in the feedback path to integrate the photo-current while maintaining a fixed potential at the photo-diode node. The positive terminal of the amplifier can be connected to an external bias, V_{comm}, which then dictates the voltage bias at which the p-n junction, V_{pd}, is clamped when the system operates in integration mode. A capacitor, Cᵢₙₜ, connects the output of the amplifier back to the negative terminal of the amplifier to provide feedback and additionally acts as an integrator. An additional and optional amplifier in unity-gain configuration can be connected through a switch to the output of the CTIA. Although each pixel is illustrated to have one photodiode and three amplifiers, it may have one photo diode and additional amplifiers and transistors. For convenience of explanation, certain embodiments are described with reference to a pixel having a structure of one photodiode and three amplifiers.

FIG. 4 shows a monolithic device having a pixel cell array with rows and columns of pixel cells. The pixel array is connected to a row selector. Under the direction of the timing and control circuit, the row selector causes each pixel cell of a selected row to transmit at least one output signal, via its respective column line, to a sample-and-hold circuit. A column bus then selectively passes the output signals from the sample-and-hold circuit to a system of components for generating pixel data.

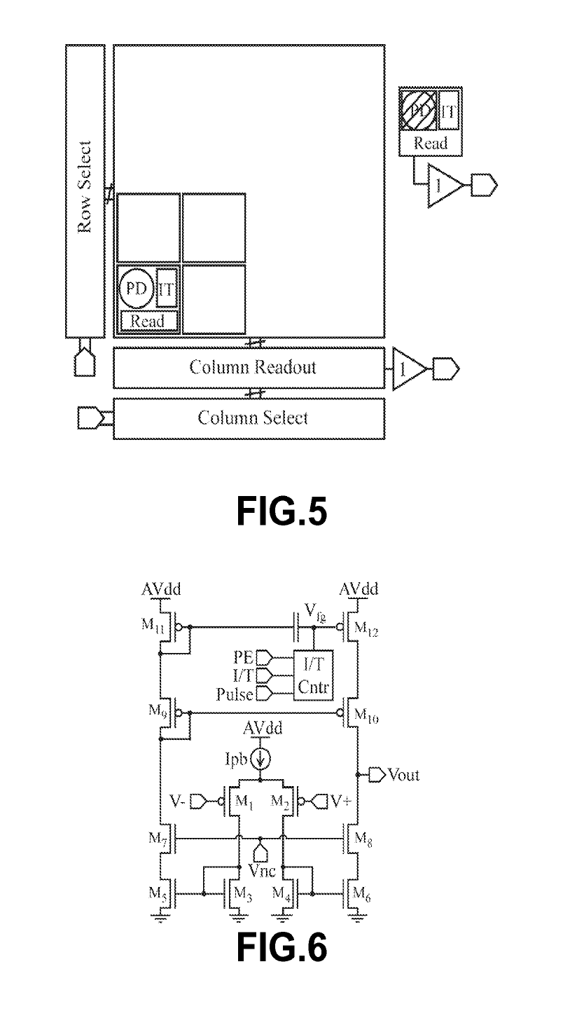

One example of CTIA architecture is shown in FIG. 5. The floating-gate based capacitive trans-impedance amplifier (CTIA) pixels are selected in a random access architecture via peripheral control to allow multiple nondestructive sampling of each pixel. In addition the CTIA has some means of compensating the offset introduced in its operation by fabrication mismatch in the components from which it is constructed. This offset compensation may be stored locally using nonvolatile storage such as a floating gate node. Capacitive trans-impedance amplifier pixels use a trans-impedance amplifier with a capacitor in the feedback path to integrate the photo-current while maintaining a fixed potential at the photo-diode node. An extra pixel that is shielded from incident light may be included in the architecture in order to provide a dark reference that is used to determine and set global biases.

One example of a chip layout is shown in FIG. 6, which is a layout of a unit pixel of a CMOS image sensor consistent with a specific embodiment. The floating gate circuits use MOSFET devices with an electrically isolated gate. The electrical isolation is achieved with a layer of oxide directly surrounding the gate. These electrically isolated devices use some of the same physical structures and principles used in EPROM, EEPROM, and common flash drives. Floating gate circuits have been used to achieve improved functionality and performance in a number of component architectures, including: trim current sources, autozero amplifiers, cancel/store offset in comparators and ADCs, to correct non-linearity in image sensors, store large arrays of analog parameters, as well as neuromorphic applications. Floating gate devices generally rely on two underlying mechanisms for non-volatile charge storage, which are hot carrier injection and Fowler Nordheim tunneling.

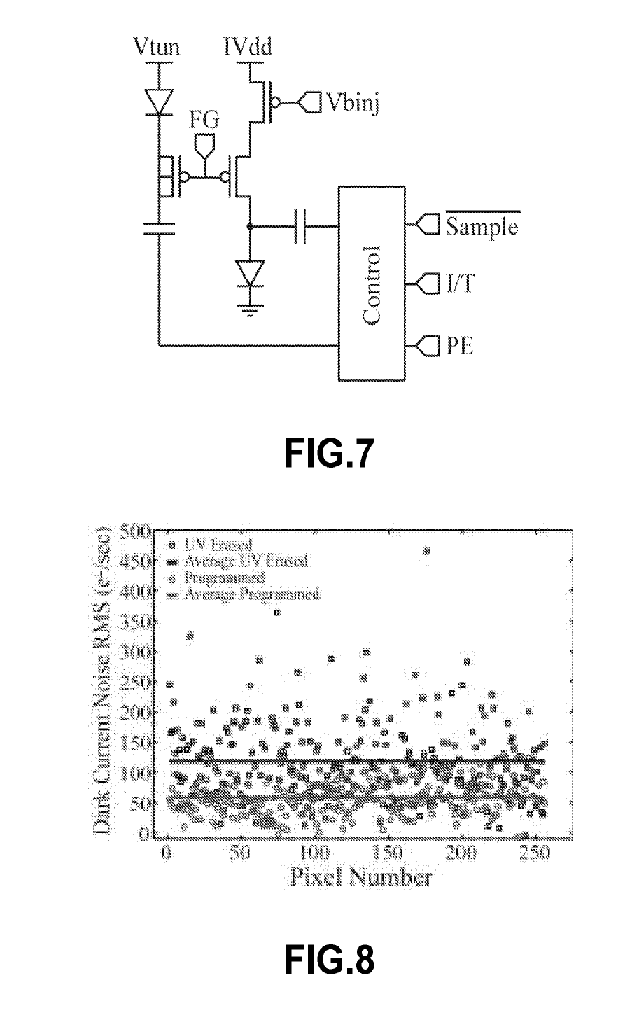

FIG. 7 shows the injection/tunneling structure of the CTIA. Because the amplifier operates in a feedback configuration, the positive and negative input terminals are held constant throughout the integration cycle. This operating point stability can allow the effect of mismatch at each transistor in the amplifier to be summed and compensated at with a single non-volatile floating gate node. Separate injection and tunneling structures can be included in each pixel. Depending on the I/T control bit, this structure either produces an injection pulse which injects a small packet of charge onto the floating node or a tunneling pulse which tunnels a small packet of charge off the node. Supply voltage Vₜᵤₙ dictates the magnitude of the current tunneled onto the floating node, while IVdd and V_{binj} determine the magnitude of current injected onto the floating node. The pulse duration can also be used to control the amount of charge injected/tunneled off the floating node. Tunneling and injection pulses may be generated on-chip using charge pump circuits which are well known to those skilled in the art.

One specific embodiment can have in-pixel floating gates as well as in-pixel injection and tunneling structures. In one embodiment, these injection and tunneling structures take up roughly 30% of the total pixel area. High voltage buffers can be implemented in the injection/tunneling structures. There may be no need for high voltage buffering as in many modern technologies, in-pixel charge pumps allow injection and tunneling under standard power supply rails. These high voltage buffers are significantly larger than minimum size devices to ensure that they can withstand high voltage supplies.

The floating gate of the CTIA can be programmed via hot carrier injection when a carrier (electron or hole) gains enough energy to surmount the energy barrier of the insulator (gate oxide). For transistors, this occurs under specific conditions. In silicon, electrons or holes gain momentum in the presence of an electric field. Due to lattice imperfections, impurities, dopants and phonons, these electrons experience collisions which reduce their momentum and overall energy. In low electric fields the total electron energy remains relatively low, and this process can result in a linear relationship between the electron drift velocity and the applied electric field. At high electric fields, however, the electron can gain sufficient energy to exceed the 1.11 eV required in silicon to break an electron-hole pair bond and cause impact ionization. In this scenario, some fraction of the electrons creates additional mobile electron-hole pairs. Electrons with excess energy above the insulator barrier voltage are considered to be hot carriers. These hot carriers are capable of surmounting the oxide barrier and in the presence of a vertical electric field are injected onto the electronically isolated gate node. Silicon dioxide is the material most commonly used as an insulator between the gate and channel of a MOS transistor, and for this material the energy barrier is 8.9 eV.

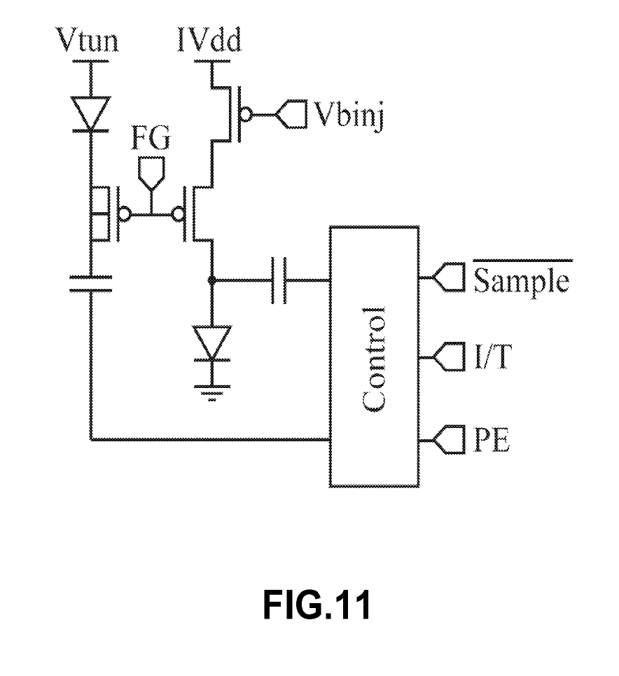

The CTIA can operate via Fowler-Nordheim tunneling by a different mechanism from hot-carrier injection. Fowler-Nordheim tunneling is a quantum effect. Quantum theory dictates that electrons act as both particles and waves. In addition, an electron's position follows a probabilistic density function known as the time-independent Schrodinger equation. This probability density function dictates that rather than an electron having an exact position, it can be found on a continuum of positions with some probability. An important aspect of quantum theory, with respect to tunneling, is that these probability density functions are continuous with respect to position, and therefore do not necessarily go to zero at the boundary of a potential well, or a discrete change in potential barrier height, such as the channel to the gate oxide of a device. In structures such as that shown in FIG. 11, the tunneling occurs in a specialized region where a large voltage is imposed across a thin dielectric insulator, inducing a strong electric field. In MOS technologies, specialized tunneling structures can be formed which use the gate oxide of the MOS transistor as the barrier in a tunneling mechanism. For MOS devices, the tunneling voltage can be applied to the gate of the transistor with respect to the source, drain and body which are all tied together.

One embodiment includes a system having an array of floating-gate based capacitive trans-impedance amplifier (CTIA) pixels with random access peripheral control to allow multiple nondestructive sampling of each pixel. The trans-impedance amplifier can have a feedback path with a capacitor to integrate the photo-current while maintaining a fixed potential at the photo-diode node. A second amplifier in unity-gain configuration can be connected through a switch to the output of the CTIA. The system can also have an additional capacitor that connects the output of the amplifier to the negative terminal of the second amplifier to provide feedback and act as an integrator.

This method, system and device can increase the dynamic range and the overall signal to noise ratio of the system. The reduction in dark current across the array increases the overall dynamic range and reduces the fixed pattern noise that arises from spatially varying dark current. Thermal carrier generation in a junction is considered to be a random process with Poisson statistics where the variability in the dark current is proportional to the magnitude of the dark current. As a result of this decrease in dark current, there is a fundamental reduction in the noise associated with that dark current. FIG. 8 shows an example of the noise associated with the dark current for each pixel with UV erasing and mismatches compensation programming under constraints. In several examples, the temporal noise associated with the dark current was reduced by about 49% on average across the entire array.

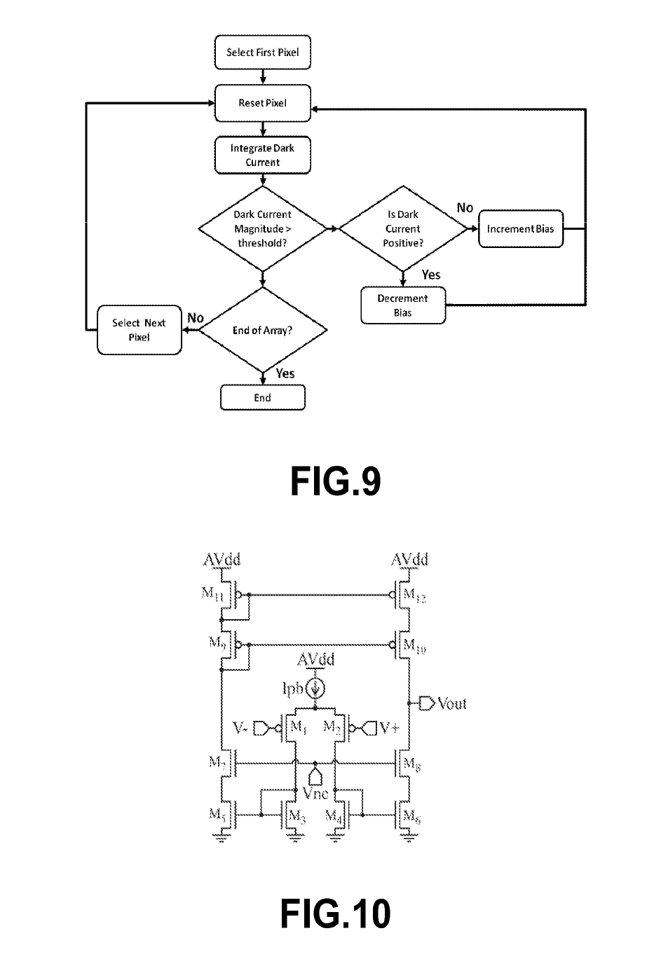

FIG. 9 is a block diagram illustrating a non-limiting example of programming which may be employed with various specific embodiments described herein. Precise programming can improve the effectiveness of the method, system, and device. As one purpose is to reduce the dark current to as close to zero as possible, the observable variable used as a programming metric becomes smaller as the system becomes programmed closer and closer to the optimal conditions. The precision of the programming system can be limited by how long the user is willing to wait in order to obtain adequate statistics about the dark current. Under certain operating conditions, the accuracy of the programming may be the highest when the operating conditions are maintained as close as possible to those under which the programming was performed. Thus, it is sometimes necessary to perform subsequent programming cycles if the operating conditions change significantly. The recurrence of programming updates can depend on the specific circuit configuration used, the desired precision, and the nature of the changes in operating conditions (i.e., change in temperature, exposure to radiation, etc.)

In one example, an array of CTIA pixels with mismatch compensation was designed in a 0.5 μm CMOS process. The pixel size was 100 μm×100 μm, with a 3600 μm² Nwell/psub photodiode yielding an active area of 36%. The explicit integration capacitance of 30 fF yields a photon conversion gain of 5.3 μV/e⁻. To achieve mismatch compensation the capacitive trans-impedance amplifier was modified to include a floating gate as shown in FIG. 10.

This system described herein can use in-pixel analog nonvolatile storage to reduce the mismatch present in an array of capacitive trans-impedance amplifier based image sensors. The CTIA based pixel exhibits low dark-current by clamping the voltage across the detector diode to nearly 0 V. This clamping of the detector reduces the field-assisted generation of carriers in the detector junction. The ability to reduce carriers is contingent upon biasing the detector to almost 0 V. Microelectronic devices inherently exhibit mismatch due to their fabrication process. These variations limit the precisions to which detector junctions can be biased. The floating gates can be used to minimize the mismatch associated with fabrication or design mismatch to precisely bias an array of CTIA detectors to their optimal biasing regime, i.e. nearly 0 V. The device and system can be designed, simulated, fabricated, and experimentally verified. For illustrative purposes, the experimental results indicate that the pixel-to-pixel standard deviation of dark current across the array can be reduced by at least 57 times.

In other embodiments, the local storage can be in the form of volatile, digital, or non-volatile memory. The introduction of a programmable memory structure or local memory into each light-detecting pixel can allow for tuning of the mechanism which sets each pixel's biasing configuration thus allowing performance to be optimized on a pixel-by-pixel basis. Volatile memory includes voltages stored on capacitors using common circuit designs such as capacitive sample and hold structures. Digital memory may be used to store digital bits locally, then the digital information can be converted to a local bias voltage using an in-pixel A/D conversion. Non-volatile analog memory can take a number of forms. The more common analog memory structures in CMOS technologies makes use of floating gate technology, which has been used in many applications products including EPROM, EEPROM, and flash memory. Floating gate technology stores charges onto “floating” nodes within the circuit which are electrically isolated from other nodes or currents by an insulating dielectric layer. The current mechanisms of tunneling and hot carrier injection are then used to adjust the stored charge. Other technologies which implement nonvolatile analog memory include, but are not limited to, magnetoresistive memory, which uses changes in resistance under the influence of a magnetic field; phase change memory which uses changes in the conductivity of chalcogenide glass as a storage medium; and ferroelectric memory which uses a layer of ferroelectric material, typically lead zirconate titanate, as a dielectric layer in a storage capacitor. One with ordinary skill in the art can select a suitable mechanism for local memory or local storage without undue experimentation.

As can be seen, one of ordinary skill in the art can select the limits of the array size, the pixel size, the components based on the limits of technology and the desired applications. For example, the array could be 2×2 or 16 M or any other size. The pixel size can also depend on the application, and in some more advanced CMOS imaging technology the pixel may be about 0.12 μM. The active area of the desired pixel size is chosen based on the application of the system. The array size is also chosen based on the application of the system. In photographic application, it may be optimal to use larger pixel size, whereas many biosensors may be benefit from smaller array size larger pixel size.

Further, the capacitance can be selected based on the desired gain. An upper bound on the capacitance can be dictated by area allocated for the device and pixel size. A lower bound can be dictated by the fabrication process. The choice of capacitance affects the photon conversion gain (number of observed volts per photon) this relationship is smaller capacitance larger gain. It also affects the noise performance of the system. For the front end system noise of the amplifier, the larger the capacitor the smaller the amplifier noise.

To achieve desired programming using a floating gate, an additional power supply with higher voltage than a nominal power supply may be added to the design. In practice this voltage may be 1.5 to 2 times larger (in magnitude) than the specified operating supply. The specific values can be selected to dictate the magnitude of tunneling or injection for each programming cycle. These voltages also can be achieved using charge-pump structures, a great variety of which are well known to those skilled in the art. One specific implementation of charge injection and tunneling structures are shown for illustrative purposes in FIG. 11 and various other figures herein. For tunneling, a positive charge pump with a high voltage supply Vₜᵤₙ can be used to provide a sufficient electric field across a tunneling device to induce tunneling current. For injection, appropriate bias conditions can be induced in a MOS transistor, typically a PMOS transistor, in order to generate hot carriers which are then collected onto the floating gate of the MOS device. In the example structure shown, a PMOS transistor with biases IV_{dd} and Vbinj can used to set the bias current which is provided at the source of the injection transistor. A charge pump may then pull the drain of the injection PMOS transistor low in order to provide a sufficient gate-to-drain and source-to-drain voltage to induce injection. The specific magnitude of injection current can be dictated by the bias current, and the specific gate-drain, source-drain voltages.

In one embodiment, a single-pixel structure can be shielded by metal and located outside of the array. This structure serves as a dark current reference. As the environmental temperature changes, the in-pixel amplifiers stray from their optimal biasing condition, however since the mismatch has been removed from each pixel across the array, the drift can be compensated for by a global bias.

In another embodiment, the photodiode arrays can be operated in an integrating mode of operation. In this mode of operation, the capacitance is reset to a reference bias and then allowed to float. The charge on the capacitance is then discharged by photo-generated current or other current.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

What is claimed:

1. A method for reducing dark current in an array of pixel cells, each pixel cell comprising a photodiode configured to receive light and generate a photocharge during an integration period, comprising the steps of:
(a) providing a substrate having an array of pixel cells, each pixel cell comprising a photodiode configured to receive light and generate a photocharge during an integration period; and
(b) suppressing the dark current by clamping the voltage across the photodiode to about zero using local storage of charge.

2. The method as claimed in claim 1, wherein the local storage in the pixel cell.

3. The method as claimed in claim 1, further comprising the step of:
creating a feedback loop with the local storage.

4. The method as claimed in claim 1, wherein the dark current is suppressed with a capacitive trans-impedance amplifier in the pixel cells, wherein trans-impedance amplifier has a floating-gate circuit that allows its operation to be precise.

5. The method as claimed in claim 1, wherein the step of correcting is performed by circuitry integrated on the monolithic substrate also includes the use of in-pixel injection structures and tunneling structures.

6. The method as claimed in claim 1, further comprising the step of:
creating a feedback loop between the amplifier and a capacitor.

7. The method as claimed in claim 1, wherein the step of correcting is performed by circuitry integrated on a substrate.

8. The method as claimed in claim 1, wherein the local storage is selected from the group consisting of volatile memory, non-volatile memory, and digital memory.

9. A device comprising:
an array of pixel cells, each pixel cell comprising a photodiode configured to receive light and generate a voltage during an integration period, wherein each pixel has local storage of charge and the voltage across the detector is nearly zero at the integration node.

10. The device as claimed in claim 9, wherein the device is monolithic.

11. The device as claimed in claim 9, further comprising
a capacitive trans-impedance amplifier in the pixel cells; and
a floating gate circuit in trans-impedance amplifier

12. The device as claimed in claim 9, wherein the local storage is volatile storage, digital storage, or non-volatile.

13. The device as claimed in claim 9, further comprising a floating gate in a feedback loop.

14. The device as claimed in claim 9, further comprising a capacitor in a feedback loop.

15. The device as claimed in claim 9, wherein the device consists of a single semiconductor chip comprising a silicon substrate with integrated circuitry integrated with a surface of the silicon substrate.

16. The device as claimed in claim 9, wherein the device is a complementary metal-oxide-semiconductor (CMOS) array.

17. The device as claimed in claim 9, the floating gate circuit is implemented using a metal-oxide-semiconductor field-effect transistor.

18. The device as claimed in claim 9, the CTIA is programmed by tunneling, hot carrier injection, or a combination thereof.

19. A system comprising:
(a) an array of pixel cells, each pixel cell comprising a photodiode configured to receive light and generate a photo detector having a voltage during an integration period, wherein each pixel has local memory, the voltage across the detector is about (0) at the integration node, and the local storage is in path with a capacitor to integrate the photo-current while maintaining a fixed potential at the integration node.

20. The system as claimed in claim 19, further comprising an additional capacitor that connects the output of the amplifier to the negative terminal of the second amplifier to provide feedback and act as an integrator.

21. The system as claimed in claim 19, wherein the photodiode is connected to the negative terminal of the second amplifier with an NMOS transistor acting as a switch between the photo-diode and the second amplifier; and the positive terminal of the second amplifier is connected to an external bias, when the system operates in integration mode.

22. The system as claimed in claim 19, further comprising a display device for displaying the corrected output.

23. The system as claimed in claim 19, further comprising structures selected from the group consisting of: tunneling structures, in-pixel structures and a combination thereof

24. The system as claimed in claim 19, wherein the circuitry for correcting the output is integrated as a monolithic device.
